(19) United States
(12) Patent Application Publication
(10) Pub. No.: US 2006/0162833 A1
(43) Pub. Date: Jul. 27, 2006

(54) Approved multi-purpose vehicle tire

(76) Inventor: Charles Patrick Bodony, Port Townsend, WA (US)

Correspondence Address: John R. Hynson;Attorney at Law, Suite 212, 7406 27th St. West, University Place, WA, 98466, US

(21) Appl. No.: 11/045,842

(22) Filed: Jan. 25, 2005

(51) Int. Cl. B60C 7/00

(52) U.S. Cl. 152/300; 152/301; 152/306; 152/333.1

(57) ABSTRACT

The invention is a light weight composite tire for use on multipurpose vehicles. The first of the tire is divided into chambers by laminated bulkheads which adds strength. The tire could be used on all terrain vehicles such as a rescue vehicle that requires light weight and the ability to be used on thin ice, mud, slush, swamps, marshes, rivers etc.

### FIELD OF INVENTION

The present invention relates generally to an improved light weight composite tire that can be utilized on rescue or all-terrain vehicles.

### BACKGROUND OF THE INVENTION

Tires for almost every type of vehicle are currently constructed of vulcanized rubber and steel belts. This type of material increases the weight of the tire which increases the amount of power required to move the vehicle to fulfill its intended purpose. For example, tractor tires, which are the approximate size and shape required for use in an all terrain rescue vehicle, weigh hundreds of pounds each which limit their use on thin ice and causes them to bog down in mud and sand. Additionally, tires of that weight require additional buoyancy if the craft is to be used in water.

When tires are only to be used on highways and other solid or paved surfaces, the weight and power requirements do not cause problems that cannot be overcome by increasing the power output of the engine which also increases the weight of the vehicle.

However, there are situations where the weight of the vehicle is of such importance in the overall design that standard rubber tires cannot work. For example, vehicles that must be used on surfaces that cannot support weight such as water, mud, beaches, snow, swamps and thin ice. Another example of the importance of tire weight would be interplanetary probes that travel on surfaces composed of dust that has collected over long periods of time. Even with terrestrial vehicles that must be transported to point of use, weight is still a critical consideration. Standard tires also increase the cost of transport of the vehicle to the location of use.

Tires used in rescue or all-terrain vehicles will both have to support the vehicle with its payload, and provide traction, as well as being light enough as to not render the vehicle unusable by sinking into the surface of its operating medium. The tires themselves can also provide flotation.

The instant invention solves all of these problems.

### SUMMARY OF THE INVENTION

The instant invention solves the twin problem of weight and strength while providing traction by using composite materials that are structurally applied to support a design weight while simultaneously providing buoyancy.

The use of molding techniques in manufacturing are well known in the art. However, to construct tires that are capable of supporting a vehicle capable of multi-surface use; particular injection techniques of composite materials must be used. The composite material used in the instant invention is a carbon fibre, Kevlar®, S-glass epoxy laminate pressure by vacuum voiding pressure-vacuum in fusion molding. The injection techniques are pressure-die injection molding of thread lugs.

The design is a central support assembly to which two casings, each resembling a half-donut shape are bonded together. In another embodiment, inside the hollow casings are a multiplicity of radial bulkheads which add support to the casings. All parts are typically glued with methacrylate structural adhesive or its functional equivalent.

The subject matter of the present invention is particularly pointed out and distinctly claimed in the concluding portion of the specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a side view of a rescue vehicle utilizing the instant inventions.

FIG. 2 is an isometric view of the preferred embodiment of the instant invention that utilizes a traction coating of the central bulkhead assembly.

FIG. 3 is a partial cross section of the central bulkhead assembly along lines A-A′ illustrating the bonding surfaces for assembly of the instant invention.

FIG. 4 is a side view of the first central bulkhead.

FIG. 5 is a side view of the second central bulkhead.

FIG. 6 is an isometric view of a second embodiment of the instant invention that does not utilize a central traction bulkhead extension of the central bulkhead.

FIG. 7 is an isometric view of a casing.

FIG. 8 is a side view of the instant invention illustrating the traction coating of the central support assembly.

FIG. 9 is an end view of the preferred embodiment of the instant invention that utilizes a traction coating on the central support assembly.

FIG. 10 is a cross-section along lines A-A′.

FIG. 11 is a cross-section along lines A-A′ that illustrates the location of the radial bulkheads.

FIG. 12 is a cross section view along lines B-B′ of the central support assembly.

FIG. 13 is a cross section view along lines B-B′ of the central support assembly that illustrates the single central bulkhead embodiment.

FIG. 14 is a cross-section along lines C-C′ illustrating the spacing of the radial bulkheads.

FIG. 15 is a side view of a radial bulkhead

FIG. 16 is a side view of a thread mounted to the traction coating edge of the instant invention.

### DESCRIPTION OF THE PREFERRED EMBODIMENTS

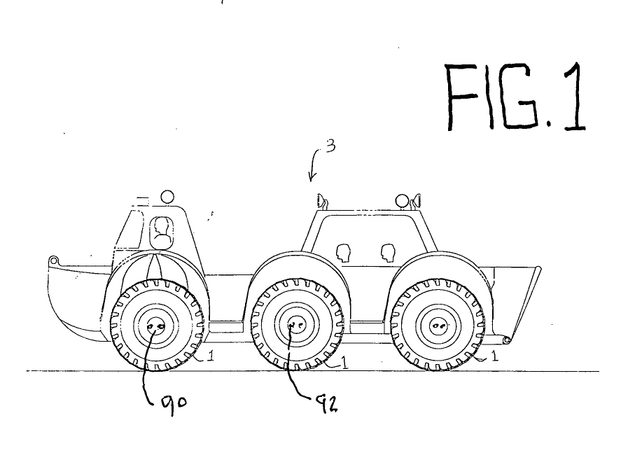

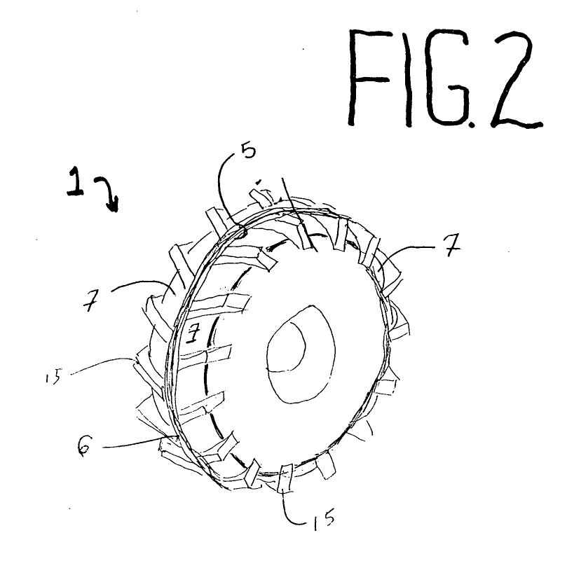

Now referring to FIG. 1. the instant invention is a light weight molded composite tire 1 that can be used on all terrain vehicles 3 that can travel over a variety of surfaces such as mud, water, snow, sand, marshes or swamps.

Central Support Assembly

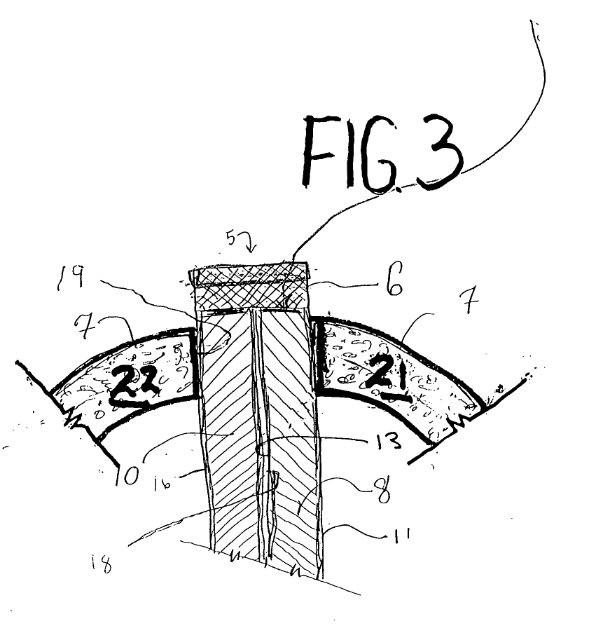

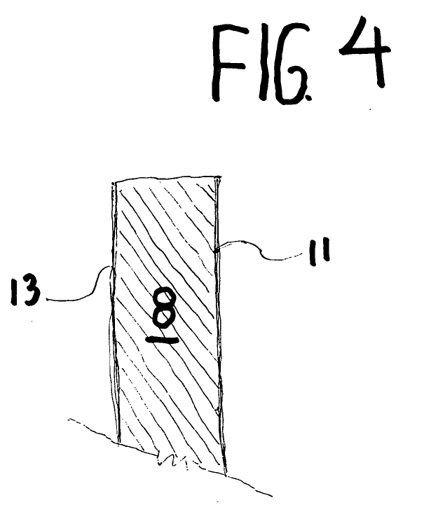

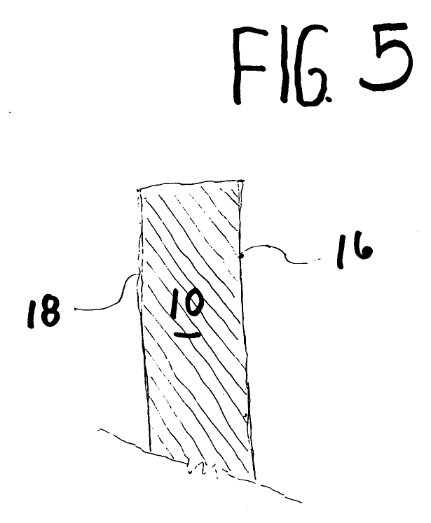

Now referring to FIG. 2, the preferred embodiment of the instant invention 1 has a dual purpose central support assembly 5 that has an optional traction coating 6 which can be used for traction in the event that the rescue vehicle, or other multipurpose vehicle, needs to travel on a paved road or other hard surface in addition to its design medium. The central support assembly 5 also increases the ability of the tire 1 to support more weight.

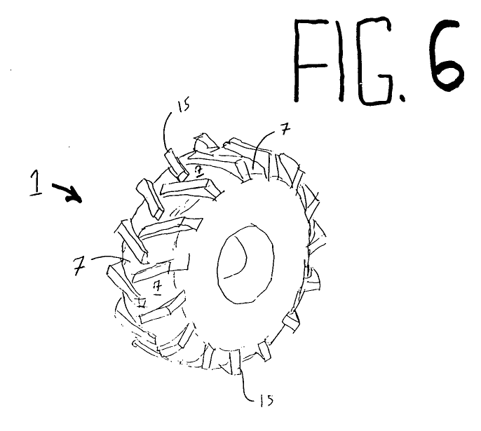

Now referring to FIG. 3, FIG. 4, and FIG. 5, the central support assembly 5 consists of a first central bulkhead 8 and second central bulkhead 10. Now referring to FIG. 4 the first central bulkhead 8 has an exterior surface 11 and interior surface 13. Now referring to FIG. 5, the second central bulkhead 10 has an exterior surface 16 and interior surface 18. Coatings, or laminations, add to the structural strength of the central bulkheads 8,10 which typically have a core of foam or honeycomb.

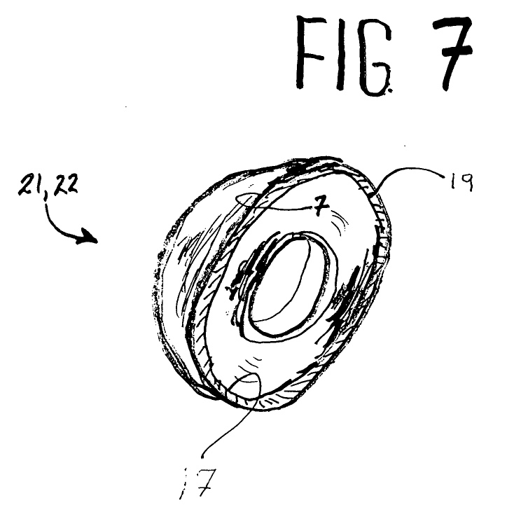

Now referring to FIG. 6, it is not necessary for the central support assembly 5, not shown, to extend through the outer surface 7 of tire 1. For applications in reduced gravity, or with a light payload, the instant invention can be constructed without a central support assembly 5, but is not recommended for rescue vehicles. This embodiment would be best utilized in applications that would mainly require the generation of forward forces in liquefied environments such as water, snow, or mud. Raised threads 15 design such as 30° grouser is recommended in these environments.

First Casing and Second Casing

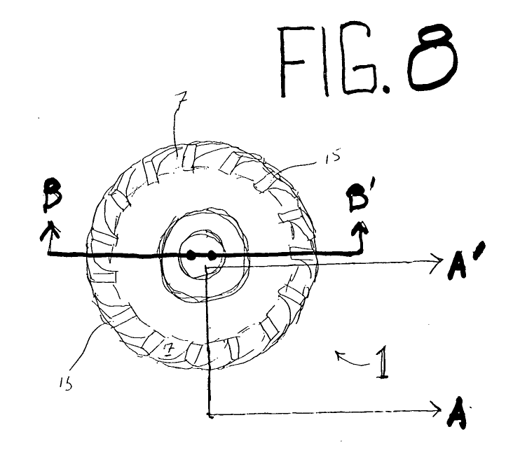

Now referring to FIG. 7 the body of the tire 1 is created by combining a first casing 21 to a second casing 22, which are typically identical, but can vary according to mounting and traction needs. In order to form a whole tire, the lips 19 of the casings 21,22 must match when placed together. Each casing 21,22 will have an exterior surface 7, an interior surface 17 and a lip 19. Each of these surfaces must be capable of bonding to the central support assembly 5. The casings 21,22 can have varying thicknesses depending upon the particular application. For a tire 1 that a diameter of about 4′ a thickness of about ¼″ can be used if a central bulkhead assembly 5 is utilized. If not central bulkhead assembly is not used the casing thickness would have to be substantially higher.

Joining the Casings to Central Bulkhead Assembly to Form the Tire

Referring again to FIG. 3, in the preferred embodiment the first casing 21 and the second casing 22 are bonded to a central support assembly 5. Specifically, the first casing 21 is bonded to a first central bulkhead 8. Then the second casing 22 is bonded to the second central bulkhead 10. After which the interior surface 13 of the first central bulkhead 8 is aligned and then bonded to the interior surface 18 of the second central bulkhead 8 forming the tire 1.

For clarity, surfaces are typical joined in the following order, which is done in three steps: The first step is to bond the first casing 21 to the first central bulkhead 8. The second step is to bond the second casing 22 to the second central bulkhead 10. The third, and final step, is to bond the two inner surfaces 13,18 of the central bulkheads 8,10 to each other. It should be noted that the flat edge 79 of each radial bulkhead 71 is also bonded to the exterior surface 13,16 of each central support bulkhead 8,10.

While the bonding of flat surfaces are illustrated, it is also contemplated that a tongue and grove, which is well know in the art, on the surfaces could be utilized to increase strength and ease of assembly. The surfaces that the tongue and grove concept could be useful for: surfaces 7,11,13,15,17,18,19. However, the use of methacrylate for bonding should provide satisfactory strength for use in a rescue vehicle.

Traction on Hard Surfaces

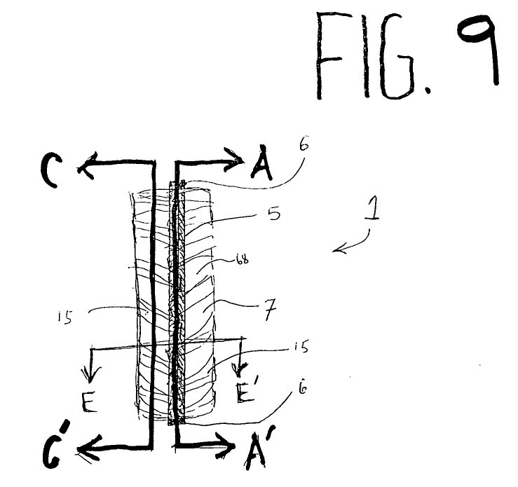

FIG. 8 is a side view of embodiment in which the central support assembly 5 does not extend through the surface 7.

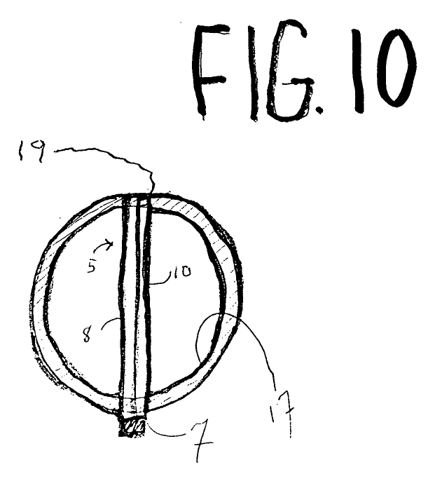

FIG. 9 is a side view of the embodiment wherein the central support assembly 5 extends through the outer surface 7.

Now referring to FIG. 10, which is a cross-section along lines E-E′ has an outer surface 7 that extends around its circumference and an has an inner surface 17 and it is divided in two by the central bulkhead assembly 5.

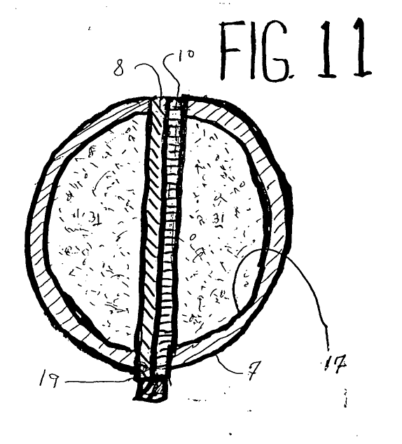

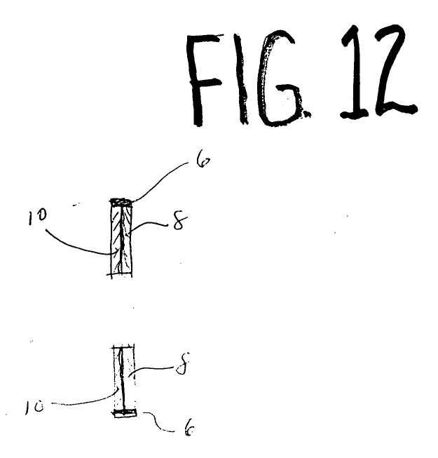

Now referring to FIG. 11, which is a cross section along lines E-E′ illustrates the use of the semi-circular disk shaped radial bulkheads 71 is fixed to the inner surface 17 in a water and air tight fit.

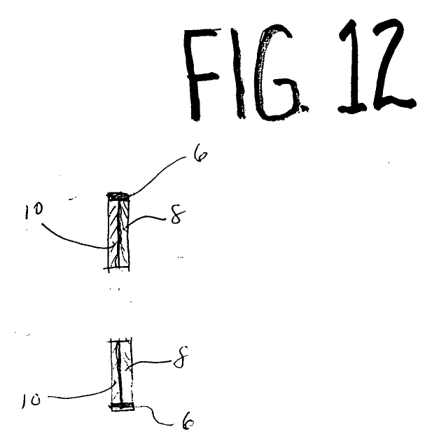

Now referring to FIG. 12, which a side view of the central support assembly 5, it would be apparent that the central support assembly 5 consists of a first inner central 8 support, and an outer central support 10 to which is bonded the traction coating 6.

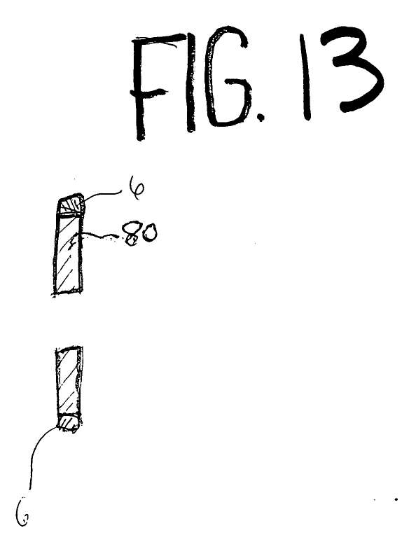

Now referring to FIG. 13, in the alternative, the central support assembly 5 can be constructed in a single bulkhead 80 depending upon the design requirements for the particular application. The casings 21,22 would then be bonded directly to the single bulkhead 80. The key consideration regarding whether or not to bond the first central bulkhead 8 and the second central bulkhead 10 is the weight to be supported. The combination that results from the bonding of the first central bulkhead 8 to the second central bulkhead 10 will produce a higher strength than a double thickness of the same material when a structural adhesive such as methacrylate is used to bind them together. Another consideration is that an increased number of surface laminations (not shown) of the central bulkheads 8,10 would increase the structural strength.

Radial Bulkheads

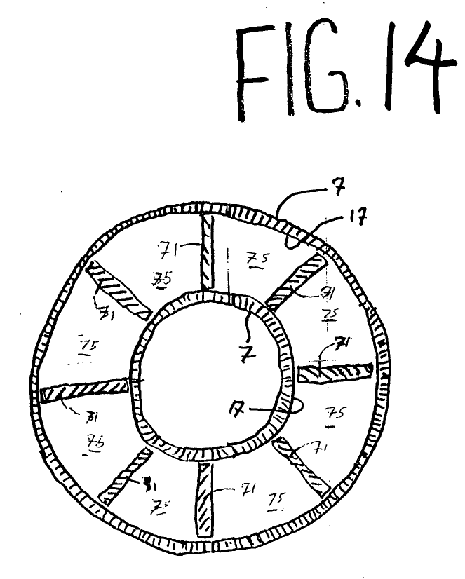

Now referring to FIG. 14 radial bulkheads 71 can be used to increase the structural integrity of instant invention. Mustrated in FIG. 14 are eight radial bulkheads 71, however, any number of radial bulkheads 71 can be utilized. The application for use on water has achieved satisfactory results with nine radial bulkheads 71 equally spaced radially around the interior of the casing.

Still referring to FIG. 14 the use of the radial bulkheads 71 creates chambers 75 that add buoyancy to the tires 1. A chamber 75 is bounded by two radial bulkheads 71,71 and the inner surface 17 of casings 21,22 and the exterior surfaces 11,16 of the central support bulkheads 8,10.

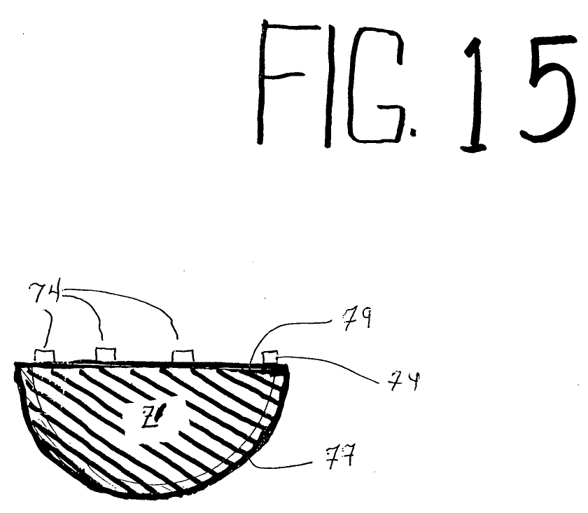

Now referring to FIG. 15 a radial bulkhead 71 has a rounded edge 77 and a straight edge 79. The rounded edge fits in air/water tight fashion against the inside surface 17 of the casings 21,22. If necessary tabs 74 can be machined of, or glued to, the straight edge 79 and a corresponding slot (not shown) can be cut into the surface of the central support bulkhead. The use of tabs 74 and slots are well know in the art. The surface on the radial bulkhead 71 could be tongue and grove as well.

The more radial bulkheads 71 that are used, the more the volume of each chamber 75 will be reduce. This will therefore reduce the buoyancy by increasing the weight of the tire and reducing the air space. However, it should be noted that when using composite materials the increase in weight is not significant, and a solid composite tire 1 is even contemplated in the case of extreme weight. The weight of a solid composite tire 1 would be considerably less than the weight of a conventional tire of the same size and shape. The use of radial bulkheads 71 increases the ability of the tire 1 to support weight.

Foam

In applications that would be used in environments that would have a risk of the tire being punctured the chambers could be filed with foam. Risk of puncture would be highest in combat situations where the tire could be pierced by bullets or shrapnel. Rocky or icy terrains also pose a significant danger for puncture. Using foam would cause a slight decrease in buoyancy due to the increase in weight, but it would prevent a larger loss in buoyancy than if a puncture would occur and a chamber 75 would fill with water or sand. Using a foam filled chamber 75 would have the added benefit of maintaining a more even tire 1 balance in the event of a puncture. The filing of one chamber 75 with sand or water would cause an increase in weight in one portion of the tire 1 would cause tire 1 unbalance.

Axil Hubs and Spindles

The use of axil hubs, or spindles, for flexible tires are well know in the art. The hub assembly (not shown) that is used with rubber tires is typically of unified construction. The smaller and thinner tires can stretch to be moved over the lip of the hub. Some larger rubber tire applications use a bifurcated hub assembly (not shown) since the rubber is too thick to stretch as does the smaller thinner tires.

Due to the composite construction the instant invention will not be flexible and will typically require a bifurcated hub that would have an inner and an outer hub section (also not shown). The optimal material for a hub on a rescue vehicle would be aluminum due to weight considerations. The specific hub required will be determined by the needs of the vehicle that utilizes the instant invention and is not germane to the instant invention.

Referring to again FIG. 1, an outer hub 90 and an exterior hub are typically fitted together and held in place by a multiplicity of hub bolts 92 that are attached to an axle.

Thread

Traction design for tires is well known in the art and the particular tread design 15 is not germane to the instant invention. However, using tires in mediums such as wet soil, sandy areas, water, or any mixture of these will require the use of treads of a particular design if the medium they are to travel on is known.

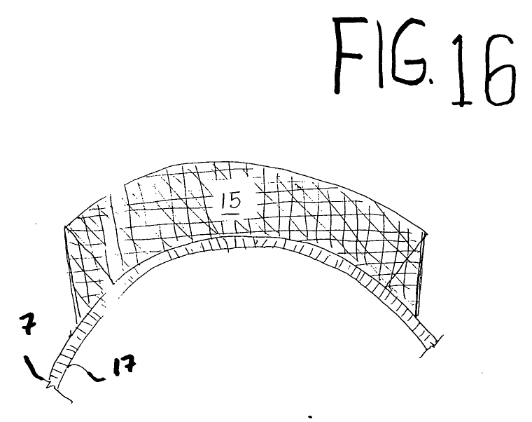

Now referring to FIG. 16, a thread 15 is mounted substantially transverse to the direction of motion of the tire 1. As mentioned infra the optimal thread 15 design for use on a rescue vehicle is 30° grouser.

### OTHER EMBODIMENTS POSSIBLE

While several embodiments of the present invention have been shown and described, it will be apparent to those skilled in the art that many changes and modifications may be made without departing from the invention in its broader aspects.

I claim:

1. A tire constructed of composite materials having a first casing and a second casing,
wherein said first casing is bonded to said second casing forming said tire.

2. A tire constructed of composite materials having a first casing and a second casing,
said first casing attached to an exterior surface of a first central bulkhead;
said second casing attached to an exterior surface of a second central bulkhead;
an interior surface of said first bulkhead aligned and attached to the an interior surface of said second central bulkhead;
forming said tire.

3. A tire constructed of composite materials having a first casing and a second casing,
said first casing attached to an exterior surface of a first central bulkhead;
said second casing attached to an exterior surface of a second central bulkhead;
an interior surface of said first bulkhead aligned and attached to the an interior surface of said second central bulkhead;
radial bulkheads being attached to an inner surface of said casings and being attached to said exterior surface of said first and second central bulkheads forming chambers, forming said tire.

5. A tire constructed of composite materials having a first casing and a second casing,
said first casing attached to an exterior surface of a first central bulkhead;
said second casing attached to an exterior surface of a second central bulkhead;
an interior surface of said first bulkhead aligned and attached to the an interior surface of said second central bulkhead;
radial bulkheads being attached an inner surface of said casings and being attached to said exterior surface of said first and second central bulkheads forming chambers;
said chambers filled with foam;
forming said tire.

6. The tires in claims 1 through where a central support assembly extends though the surface of said tire, and said central support assembly having a traction coating.
